(19) United States
(12) Patent Application Publication
(10) Pub. No.: US 2025/0139691 A1
(43) Pub. Date: May 1, 2025

(54) SYSTEMS AND METHODS FOR CLOUD-BASED CART ASSISTANCE AND TRACKING

(71) Applicant: Sandhe, LLC, Chicago, IL (US)

(72) Inventors: Glen Follis, Hammond, IN (US); Justin Hutton, Hammond, IN (US)

(21) Appl. No.: 18/927,113

(22) Filed: Oct. 25, 2024

Related U.S. Application Data
(60) Provisional application No. 63/545,844, filed on Oct. 26, 2023.

(51) Int. Cl. G06Q 30/0645; G06Q 10/20

(52) U.S. Cl. CPC G06Q 30/0645; G06Q 10/20

(57) ABSTRACT

Systems and methods for cloud-based cart assistance and tracking are disclosed. A cart assistance application (app) of a computing device obtains an arrival window and departure window to and from a service location indicated by a user. A server receives the arrival window, departure window, and service location from the computing device, and identifies a cart of a plurality of carts that is available at the service location for the arrival window and the departure window. The server comprises and/or has access to a memory storing a state of an inventory of a plurality of carts configured to traverse a beach environment. The server updates an electronic list to indicate the state of the cart is reserved for the user.

### FIELD

The present disclosure generally relates to systems and methods for cart assistance, and more particularly to, systems and methods for cloud-based cart assistance and tracking.

### BACKGROUND

Generally speaking, beachgoers bring implements (e.g., towels, chairs, toys, umbrellas) to a beach to aid them in enjoying their beach experience. In conventional techniques, beachgoers transport implements from e.g., a car in a parking lot, to a suitable location on a coastline, and back again, by hand; however, for many beachgoers the transport process is demanding and prohibitory. For example, an elderly couple treating their grandchildren to a day at the beach may not be physically capable of transporting the day's food, water, and toys to the coastline. In another example, a sunburnt family may dread returning to their car after a long day at the beach with no other option than to carry their unused firewood, dirty toys, and refuse. Accordingly, conventional techniques are onerous and inefficient.

For the foregoing reasons, there is a need for systems and methods for cloud-based cart assistance and tracking. The systems and methods disclosed herein may provide solutions to these problems and may provide solutions to other drawbacks of conventional techniques.

### SUMMARY

Generally, as described herein, systems and methods are described for cart assistance. Such systems and methods provide a remote (cloud-based) cart assistance solution for overcoming problems that arise when arriving to, and departing from, a location. For example, the systems and methods described herein may be used to efficiently coordinate and/or track a plurality of manual, semi-autonomous, and/or autonomous carts assisting users transporting items to and from a location. In some aspects, the systems and methods described herein may be used to provide cart assistance according to the current geolocation of one or more users and/or carts.

The systems and methods for cloud-based cart assistance and tracking described herein may be implemented on one or more processors, either of a user computing device (e.g., such as one or more processors of a mobile device), and/or one or more processors of a cloud-based computer or server.

In one example aspect, a cart assistance application (app) may be downloaded or installed on a user computing device, such as an APPLE IPHONE or GOOGLE ANDROID phone through the APPLE APP store or GOOGLE PLAY store, respectively. A user may open the app to create a user profile. Creation of the profile may include a user providing or selecting preferences, such as allowing permissions for the current geolocation of the user to be obtained by the app via the computing device. In addition, creation of a profile may involve the user indicating a preferred (e.g., preset) service location(s), such as a frequently visited beaches, parks, hotels, etc. where a service location provides cart assistance.

In various aspects the user may reserve a cart for assistance by indicating a time, or window of time, the user may arrive to a service location and/or depart a service location. Such information (e.g., arrival window, departure window, service location) may serve as the user initiating a reservation and be referenced herein as “reservation data.” In various aspects, reservation data may be stored on the user computing device and/or in a backend server and may be accessed, and/or edited by the user on a respective user computing device, e.g., via a display screen.

Once a user's reservation data is indicated, the server may receive the reservation data, and identify a cart of a plurality of carts that is available at the service location for the arrival window and departure window. A service location may include a plurality of carts for assisting users before, during, and/or after their time at the location (e.g., coastline). Accordingly, the server may store a state of an inventory of the plurality of carts at the service location, the state of a cart indicating, for example, whether the cart is available (e.g., checked-in, not reserved, functioning), and/or unavailable (e.g., checked-out, reserved, non-functioning, broken) for windows of time. The server may identify a cart from the stored inventory that is available at the service location for the arrival window and departure window indicated by the reservation data of the user, and update an electronic list to indicate the state of the cart is reserved for the user.

In various aspects, the current geolocation of one or more users may be used by the systems and methods described herein. For example, the current geolocation of a user may be used to reserve a cart for the user, to update a state of a cart to a checked-out state, to notify a user to return a cart depending on the current geolocation of a second user, to cause a semi-autonomous cart to follow a user, to cause an autonomous cart to travel to the current geolocation of a user, etc. In this way, the disclosure of the invention may enable cart assistance by providing the user with online reservation of a cart at a location, such as the beach. More importantly, a user may enjoy a visit to the beach without the strain of coordinating assistance for transporting their items from the parking lot to the coastline and/or back again.

More specifically, as described herein, a method for cloud-based cart assistance and tracking is disclosed. The method comprises obtaining, by one or more processors of a computing device via a display, an arrival window and a departure window of a user to and from a service location, respectively, wherein the arrival window, departure window, and service location are indicated by the user. The method further comprises receiving, by one or more processors of a server via the computing device, the arrival window, the departure window, and the service location from the computing device. The server may comprise one or more processors and a memory, and the server may be communicatively coupled to the computing device. The method further comprises identifying, by one or more processors of the server, a cart of a plurality of carts that is available at the service location for the arrival window and the departure window. The server may store the plurality of carts on the memory of the server as an electronic list defining a state of inventory of the plurality of carts configured to traverse a beach environment. The method further comprises updating, by one or more processors of the server, the electronic list to indicate the state of the cart is reserved for the user.

In addition, as described herein, a system for cloud-based cart assistance and tracking is disclosed. The system comprises a cart assistance application (app) comprising app computing instructions configured to execute on one or more processors of a computing device. The app computing instructions, when executed by the one or more processors of the computing device, may cause the one or more processors to obtain, from a display of the computing device, an arrival window and a departure window of a user to and from a service location, respectively. The arrival window, departure window, and service location may be indicated by the user. The system further comprises a server communicatively coupled to the cart assistance app. The server may comprise one or more processors and a memory. The memory may store a state of an inventory of a plurality of carts configured to traverse a beach environment. The memory may further store server computing instructions configured to execute on the one or more processors of the server. The server computing instructions, when executed by the one or more processors of the computing device, may cause the one or more processors of the server to receive, from the computing device, the arrival window, the departure window, and the service location. The server computing instructions when executed by the one or more processors, may further cause the one or more processors to identify a cart of the plurality of carts that is available at the service location for the arrival window and the departure window. The server computing instructions when executed by the one or more processors, may further cause the one or more processors to update an electronic list to indicate the state of the cart is reserved for the user.

In accordance with the above, and with the disclosure herein, the present disclosure relates to improvements to other technologies or technical fields at least because the present disclosure describes or introduces improvements to computing devices in the cart assistance field, whereby the systems and methods execute on computing devices and improves the field of cloud-based cart assistance, with server(s) coordinating user demand for cart assistance of a plurality of users and tracking carts to provide efficient and effortless cart assistance for the user.

Such systems and methods are configured to efficiently coordinate cart assistance for minimal cart movement, and thus can operate on a limited inventory of carts, can reduce energy requirements for cart assistance, can reduce impact of carts (increase longevity), and can reduce user wait times for carts. For example, cart reservation may optimize the use of carts by determining which carts should be used by which user at what time(s). Further, cart tracking may optimize the use of carts by determining which carts should be used by which user at what time(s) and at which location(s), so that carts may efficiently assist users depending on the location of the cart and the location of the user. Such optimization frees up the resources of an underlying computing system, thereby making it more efficient.

The present disclosure may include applying an abstract idea of the claim elements with, or by use of, a particular machine, e.g., a manual cart, a semi-autonomous cart, and/or autonomous cart. The cart plays a significant role in permitting the claimed systems and methods because users could not be assisted without the cart. For example, a user may need assistance to traverse a beach environment; however, without a cart, nonetheless a cart reserved according to the systems and methods of the present disclosure, the user may not receive the required assistance to traverse the beach environment. Accordingly, the cart is a particular machine.

In addition, the present disclosure includes specific features other than what is well-understood, routine, conventional activity in the field, and that add unconventional steps that confine the claim to a particular useful application, e.g., systems and methods for cloud-based cart assistance and tracking.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example computing system configured for cloud-based cart assistance and tracking, in accordance with various aspects disclosed herein.

FIG. 2 illustrates an example method for cloud-based cart assistance and tracking, in accordance with various aspects disclosed herein.

FIG. 3 illustrates an example graphic user interface (GUI) as rendered on a display screen of a user computing device regarding cart assistance, in accordance with various aspects disclosed herein.

FIG. 4 illustrates an exemplary plan view implementation of a system for cloud-based cart assistance and tracking, in accordance with various aspects disclosed herein.

FIG. 5 illustrates a further exemplary implementation of a system for cloud-based cart assistance and tracking, in accordance with various aspects disclosed herein.

FIG. 6 illustrates a further exemplary implementation of a system for cloud-based cart assistance and tracking, in accordance with various aspects disclosed herein.

FIG. 7 illustrates a further exemplary implementation of a system for cloud-based cart assistance and tracking, in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

The present disclosure relates to systems and methods for cloud-based cart assistance and tracking. Such systems and methods comprise a cart assistance application (app) of a computing device (e.g., mobile device) obtaining an arrival window and departure window to and from a service location. A server may receive the obtained information from the computing device and reserve a cart for the user by identifying a cart of a plurality of carts configured to traverse a beach environment that is available at the indicated arrival window, departure window, and service location, and updating an electronic list to indicate the state of the cart is reserved for the user.

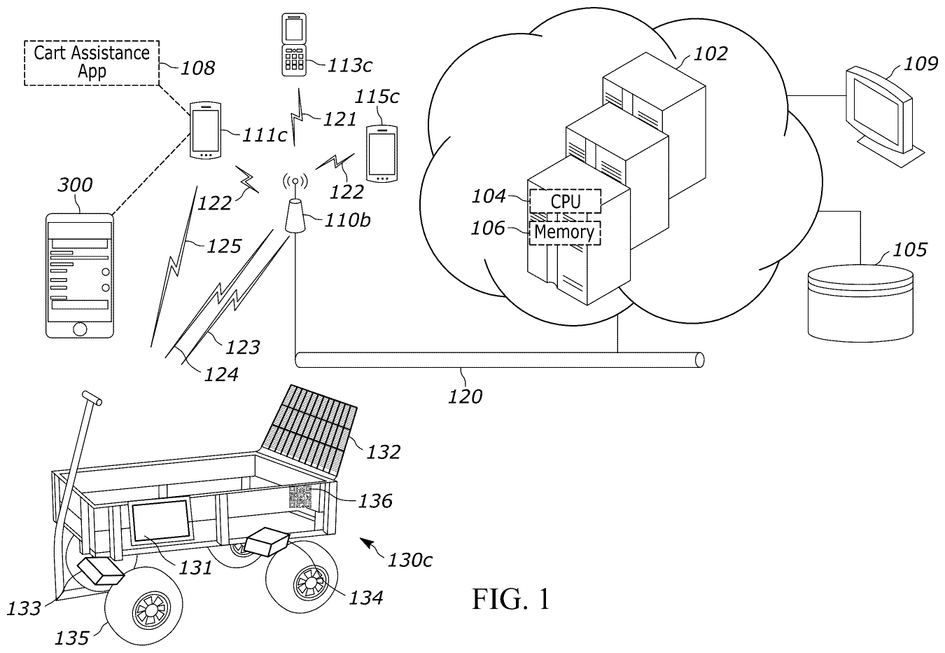

FIG. 1 illustrates a system 100 configured for cloud-based cart assistance and tracking, in accordance with various aspects disclosed herein. In the example aspect of FIG. 1, cart assistance system 100 includes server(s) 102, which may comprise one or more computer servers. In various aspects server(s) 102 comprise multiple servers, which may comprise multiple, redundant, or replicated servers as part of a server farm. In still further aspects, server(s) 102 may be implemented as cloud-based servers, such as a cloud-based computing platform. For example, server(s) 102 may be any one or more cloud-based platform(s) such as MICROSOFT AZURE, AMAZON AWS, or the like. Server(s) 102 may include one or more processor(s) 104 as well as one or more computer memories 106.

Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 106 may store an operating system (OS) (e.g., Microsoft Windows, Linux, UNIX, etc.) capable of facilitating the functionalities, apps, methods, or other software as discussed herein. Additionally, or alternatively, reservation data, user data, etc., may also be stored in memorie(s) 106 and/or in a database 105, which is accessible or otherwise communicatively coupled to server(s) 102. In addition, memories 106 may also store machine readable instructions, including any of one or more application(s) (e.g., a cart assistance application as described herein), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the processor(s) 104. It should be appreciated that given the state of advancements of mobile computing devices, all of the processes functions and steps described herein may be present together on a mobile computing device (e.g., computing device 111c). In some aspects, memories 106 may store a state of an inventory of a plurality of carts (e.g., cart 130c) configured to traverse a beach environment, in accordance with techniques described herein. In some aspects, the state of an inventory of a plurality of carts may be stored by memories 106 as an electronic list.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosure herein.

Processor(s) 104 may interface with memory 106 via the computer bus to execute an operating system (OS). Processor(s) 104 may also interface with the memory 106 via the computer bus to create, read, update, delete, or otherwise access or interact with the data stored in memories 106 and/or the database 105 (e.g., a relational database, such as Oracle, DB2, MySQL, or a NoSQL based database, such as MongoDB). The data stored in memories 106 and/or database 105 may include all or part of any of the data or information described herein, including, for example, an arrival window and a departure window of a user to and from a service location, a geolocation of a user, a geolocation of a cart, an electronic list to indicate a state of an inventory of a plurality of carts configured to traverse a beach environment, etc.

Server(s) 102 may further include a communication component configured to communicate (e.g., send and receive) data via one or more external/network port(s) to one or more networks or local terminals, such as computer network 120 and/or terminal 109 (for rendering or visualizing) described herein. In some aspects, server(s) 102 may include a client-server platform technology such as ASP.NET, Java J2EE, Ruby on Rails, Node.js, a web service or online API, responsive for receiving and responding to electronic requests. The server(s) 102 may implement the client-server platform technology that may interact, via the computer bus, with the memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various aspects, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some aspects, computer network 120 may comprise a private network or local area network (LAN). Additionally, or alternatively, computer network 120 may comprise a public network such as the Internet.

Server(s) 102 may further include or implement an operator interface configured to present information to an administrator or operator and/or receive inputs from the administrator or operator. As shown in FIG. 1, an operator interface may provide a display screen (e.g., via terminal 109). Server(s) 102 may also provide I/O components (e.g., ports, capacitive or resistive touch sensitive input panels, keys, buttons, lights, LEDs), which may be directly accessible via, or attached to, server(s) 102 or may be indirectly accessible via or attached to terminal 109. In some aspects, an administrator or operator may access the server(s) 102 via terminal 109 to review information, make changes, and/or perform other functions as described herein.

In some aspects, server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the app or computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

In some aspects, at least one of a plurality of machine learning (ML) methods and algorithms may be applied by one or more modules which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various aspects, the implemented ML methods and algorithms are directed toward at least one of a plurality of categorizations of ML, such as supervised learning, unsupervised learning, and reinforcement learning. The one or more modules may be stored, for example, on memorie(s) 106 and/or database 105.

In certain aspects, the ML based algorithms may be included as a library or package executed on server(s) 102. For example, libraries may include the TensorFlow based library, the Pytorch library, and/or the scikit-learn Python library.

In various aspects, an ML module may employ supervised learning, which involves identifying patterns in existing data to make predictions about subsequently received data. Specifically, the ML module may be “trained” using training data, which includes example inputs and associated example outputs. Based upon the training data, the ML module may generate a predictive function which maps outputs to inputs and may utilize the predictive function to generate ML outputs based upon data inputs. The exemplary inputs and exemplary outputs of the training data may include any of the data inputs or ML outputs described above. In exemplary embodiments, a processing element may be trained by providing it with a large sample of data with known characteristics or features.

In some aspects, the ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In certain aspects, the ML module may employ reinforcement learning, which involves optimizing outputs based upon feedback from a reward signal. Specifically, the ML module may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The ML module may comprise a set of computer-executable instructions implementing ML loading, configuration, initialization and/or operation functionality. The ML module may include instructions for storing trained models (e.g., in the database 105). As discussed, once trained, the one or more trained ML models may be operated in inference mode, whereupon when provided with de novo input that the model has not previously been provided, the model may output one or more predictions, classifications, etc., as described herein.

With further reference to FIG. 1, server(s) 102 may be communicatively connected, via computer network 120, to the one or more user computing devices 111c, 113c, 115c and/or cart 130c via base station 110b. In this example aspect, a single cart 130c may be communicatively connected to the server(s) 102; however, in various aspects, one or more carts (e.g., cart 130c) may be communicatively connected to the server(s) 102. In some aspects, base station 110b comprises a cellular base station, such as a cell tower, communicating to the one or more user computing devices 111c, 113c, 115c and/or cart 130c via wireless communications 121 based on any one or more of various mobile phone standards, including NMT, GSM, CDMA, UMMTS, LTE, 5G, or the like. Additionally, or alternatively, base stations 110b may comprise routers, wireless switches, or other such wireless connection points communicating to the one or more user computing devices 111c, 113c, 115c via wireless communications 122 based on any one or more of various wireless standards, including by non-limiting example, IEEE 802.11a/b/c/g (WIFI), the BLUETOOTH standard, or the like.

Additionally, or alternatively, the base station 110b may communicate with the cart 130c via wireless communication 123 based on any one or more of various mobile phone standards, including NMT, GSM, CDMA, UMMTS, LTE, 5G, or the like. Additionally, or alternatively, the routers, wireless switches, and/or other such wireless connection points of base stations 110b may communicate to the cart 130c via wireless communications 124 based on any one or more of various wireless standards, including by non-limiting example, IEEE 802.11a/b/c/g (WIFI), the BLUETOOTH standard, or the like. Additionally, or alternatively, cart 130c may be communicatively connected to any of the one or more computing devices 111c, 113c, 115c via wireless communications 125 based on any one or more various wireless standards, including by non-limiting example, IEEE 802.11a/b/c/g (WIFI), the BLUETOOTH standard, or the like.

Any of the one or more user computing devices 111c, 113c, 115c and/or cart 130c may comprise mobile devices and/or client devices for accessing and/or communications with server(s) 102. Such mobile devices may comprise one or more mobile processor(s) and/or an imaging device for capturing images, such as images as described herein (e.g., image containing a two-dimensional (2D) barcode). In various aspects, user computing devices 111c, 113c, 115c and/or cart 130c may comprise a mobile phone (e.g., a cellular phone), a tablet device, a personal data assistance (PDA), or the like, including, by non-limiting example, an APPLE IPHONE or IPAD device or a GOOGLE ANDROID based mobile phone or tablet. Additionally, in various aspects, an electronic device and/or display device, as described herein, may comprise a mobile phone (e.g., a cellular phone), a tablet device, a personal data assistance (PDA), or the like, including, by non-limiting example, an APPLE IPHONE or IPAD device or a GOOGLE ANDROID based mobile phone or tablet.

In various aspects, the one or more user computing devices 111c, 113c, 115c and/or cart 130c may implement or execute an operating system (OS) or mobile platform such as APPLE iOS and/or Google ANDROID operation system. Any of the one or more user computing devices 111c, 113c, 115c and/or cart 130c may comprise one or more processors and/or one or more memories for storing, implementing, or executing computing instructions or code, e.g., a mobile application, as described in various aspects herein. As shown in FIG. 1, cart assistance app 108 may also be stored locally on a memory of a user computing device (e.g., user computing device 111c).

User computing devices 111c, 113c, 115c and/or cart 130c may comprise a wireless transceiver to receive and transmit wireless communications (e.g., 121-124) to and from base station 110b. In various aspects, data (e.g., reservation data, current geolocation, digital images) may be transmitted via computer network 120 to server(s) 102.

In addition, the one or more user computing devices 111c, 113c, 115c and/or cart 130c may include a digital camera, digital video camera, and/or otherwise imaging capture device or system for capturing or taking digital images and/or frames. Each digital image may comprise LiDAR, ToF, and/or pixel data, which may be used for imaging analysis as described herein. For example, a digital camera and/or digital video camera of, e.g., any of user computing devices 111c, 113c, 115c, and/or cart 130c may be configured to take, capture, or otherwise generate digital images and, at least in some aspects, may store such images in a memory of a respective user computing devices. Additionally, or alternatively, such digital images may also be transmitted to and/or stored on memorie(s) 106 and/or database 105 of server(s) 102.

Still further, each of the one or more user computer devices 111c, 113c, 115c may include a display screen for displaying graphics, images, text, instruction(s), data, pixels, features, and/or other such visualizations or information as described herein. In various aspects, graphics, images, text, instruction(s), data, pixels, features, and/or other such visualizations or information may be received from server(s) 102 for display on the display screen of any one or more of user computer devices 111c, 113c, 115c. Additionally, or alternatively, a user computer device may comprise, implement, have access to, render, or otherwise expose, at least in part, an interface or a graphic user interface (GUI) for displaying text and/or images on its display screen.

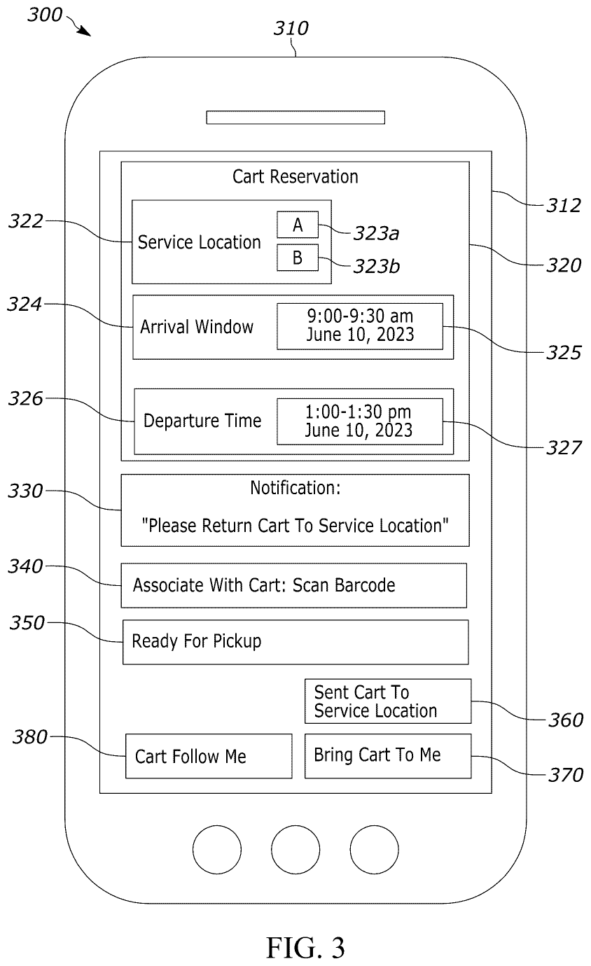

In various aspects, a display screen may also be used for providing information, instructions, and/or guidance to the user of a given device (e.g., user computing device 111c). For example, a display screen may be used to provide a user with alerts, notifications, amount of time until their departure window will lapse, etc., as described further in FIG. 3. Additionally, or alternatively, a display screen may be configured to enable users to provide information (e.g., arrival window, departure window, service location, instructions) to the server(s) 102 and/or be obtained by the cart assistance app (e.g., cart assistance app 108). For example, users may provide information to the server(s) 102 and/or cart assistance app 108 via inputting information into the display screen(s) (e.g., display device 131). In some examples, the information may be transmitted to the server(s) 102 via the base station 110b and the computer network 120.

As illustrated in FIG. 1, the cart 130c may include a display device 131, a solar panel 132, sensor(s) 133, maintenance sensor(s) 134, one or more wheel(s) 135, and two-dimensional (2D) barcode 136. The cart 130c may be configured to traverse a beach environment, an urban environment, any environment where cart assistance may be desired, e.g., by a user, and/or any combination thereof. The display device 131 may be of similar function and purpose to the display screen(s) of user computing devices 111c, 113c, 115c, as described herein. In the alternative, the display device 131 may be a standalone display device (e.g., a proprietary display device) configured for cart assistance and/or tracking. The 2D barcode 136 may be a universal product code (UPC), a quick response (QR) code, and/or any combination thereof, as discussed further in FIG. 3. The solar panel 132 may be a monocrystalline photovoltaic (PV) panel, polycrystalline PV panel, thin-film PV panel, any other type of PV panel capable of converting light (e.g., sunlight) into electricity, and/or any combination thereof. The electricity generated by the solar panel 132 may be utilized by the cart 130c to power e.g., display device 131, sensor(s) 133, maintenance sensor(s) 134, a motor (not shown) attached to wheel(s) 135 of the cart 130c, a mobile device such as computing device 111c, a battery (not shown), any other electronic device, and/or any combination thereof. The solar panel 132 may output electricity as direct current (DC) and/or convert electricity into alternating current (AC).

The sensor(s) 133 may be configured as wireless transceivers, as previously described herein, to communicate with base station 110b via wireless communication 123-124 and/or communicate with any of the one or more computing devices 111c, 113c, 115c via wireless communications 125.

The maintenance sensor(s) 134 may be configured to monitor the performance and/or function of the cart 130c, including any components of the cart 130c described herein. Specifically, the maintenance sensor(s) 134 may be communicatively connected to the display device 131, the solar panel 132, the sensor(s) 133, and/or any combination thereof. Accordingly, the maintenance sensor(s) 134 may monitor the performance and/or function of the display device 131, the solar panel 132, the sensor(s) 133, and/or any combination thereof, and generate data indicating cart performance metrics. The maintenance sensor(s) 134 may subsequently transmit a maintenance signal indicating cart performance metrics to sever(s) 102 via, for example, sensor(s) 133. For example, the maintenance sensor(s) 134 may monitor the power output of the solar panel 132, the power level and/or charging capacity of a power source (not shown) for the cart 130c such as a battery, the touch sensitivity of display device 131, etc., and generate a maintenance signal based on the cart performance metrics. The server(s) 102, subsequent to receiving the maintenance signal, may, for example, update the electronic list based on the maintenance signal, as described further elsewhere herein.

Additionally, or alternatively, the maintenance sensor(s) 134 may include instruments capable of monitoring the mechanical performance and/or mechanical function of the cart 130c, such as pressure sensors (not shown) proximate to the one or more wheel(s) 135, sensor(s) measuring the output power of a motor (not shown), etc.

In some aspects, the cart 130c may be autonomous and/or semi-autonomous. Generally, the cart 130c may include hardware and/or software to enable the cart to be autonomous and/or semiautonomous. Specifically, the cart 130c may be configured to travel to and from a location independently and/or by guidance from e.g., a user. The cart 130c may include hardware (e.g., motor, drive belt, steering mechanism) configured to move, steer, direct, guide, and/or any combination thereof, the cart 130c to and from a location. As previously described herein, the cart 130c may include an image capturing device. In some aspects, images captured by the image capturing device may be processed locally and/or on the server(s) 102 and inform the movement of the cart 130c. In some aspects, any information (e.g., performance metrics, maintenance signal, reservation data, etc.) associated with one or more carts (e.g., cart 130c) may be stored locally by a cart and/or stored by the server(s) 102 as cart data.

In some aspects, computing instructions and/or applications executing at a mobile device (e.g., computing device 111c) may be communicatively connected to one or more processors (e.g., processors 104) of a server (e.g., server(s) 102) for cart assistance, as described herein. For example, one or more processors of a user computing device (e.g., 111c) may be communicatively coupled to one or more processors (e.g., processor(s) 104) of server(s) (e.g., server(s) 102) via a computer network (e.g., computer network 120). In such aspects, a cart assistance app (e.g., cart assistance app 108) executing on the one or more processors of the computing device may be communicatively coupled to the server(s) 102. In such aspects, the server(s) 102 may include a memory (e.g., memory 106) storing a state of an inventory of a plurality of carts (e.g., cart 130c) configured to traverse a beach environment. The cart assistance app may be configured to implement, or partially implement, (1) obtaining, by one or more processors of a computing device via a display, an arrival window and a departure window of a user to and from a service location, respectively, wherein the arrival window, departure window, and service location are indicated by the user; and the server, may be configured to implement, or partially implement, (2) receiving, by one or more processors of a server via the computing device, the arrival window, the departure window, and the service location from the computing device, (3) identifying, by one or more processors of the server, a cart of a plurality of carts that is available at the service location for the arrival window and the departure window, and (4) updating, by one or more processors of the server, the electronic list to indicate the state of the cart is reserved for the user.

In some aspects, service staff and/or operators of a service location may utilize a cart demand value to ensure a sufficient number of carts are operational at a service location (e.g., service location 422) to provide cart assistance to users. A cart demand value may indicate, for example, the number of carts required to meet the user demand for cart assistance. For example, on a day with 100 users visiting the beach and/or needing cart assistance, a fleet of 20 carts may be required to provide cart assistance services. In this example, the cart demand value may be 20 carts. Various factors may influence the demand for cart assistance at a location (e.g., beach), such as weather, water temperature, hours of daylight, calendar holiday schedule, hours of operation (e.g., a beach opening at 6:00 am and closing at 9:00 pm) of a location, etc.

In some aspects, server(s) 102 may (1) determine a cart demand value for a future period of time based on one or more of (i) the electronic list, (ii) reservation data, (iii) user data, or (iv) weather data, (2) determine whether the cart demand value is greater than the inventory of the plurality of carts during the future period of time, and (3) responsive to determining the cart demand value is greater than the inventory of the plurality of carts during the future period of time, alert, via an electronic device, service staff. The electronic list may indicate the states of one or more carts on any day the electronic list was updated and/or regards. For example, the electronic list may indicate the state of cart (e.g., cart 130c) was updated to a checked-out state at 9:10 am a year prior, and further indicate a cart (e.g., cart 130c) is reserved for a user 2 days in the future. Reservation data may include historical reservation data (e.g., arrival window, departure window, service location) of days prior, reservation data for days in the future for one or more users, app traffic data (e.g., app usage metrics, incomplete reservations, number of users visiting app, etc.), and/or any combination thereof. For example, reservation data may indicate 250 users reserved a cart for Jul. 4, 2022, by Jul. 2, 2022, and additionally indicate by Jul. 3, 2022, 500 users reserved a cart for Jul. 4, 2022. Further, the reservation data may indicate 400 users reserved a cart for Jul. 4, 2023, by Jul. 2, 2023 (in this example the present day). Accordingly, a cart demand value for Jul. 4, 2023, may be determined (predicted) based on reservation data.

User data may include information from the electronic list attributable to the user (e.g., cart 130c checked-out by the user), reservation data attributable to the user (e.g., reservation indicated by the user), geolocation data of the user indicating previously obtained/received current geographic location(s), a profile of a user as described herein, metrics of a user, such as a reliability metric indicating the probability a user will check-out a cart when the user reserves a cart, a promptness metric indicating the probability a user will return a cart etc., any data regarding a user as described herein, and/or any combination thereof. Weather data may indicate the weather at the service location on any given day, such as Jul. 4, 2022, and/or the weather forecast for any given day, such as Jul. 4, 2023. The electronic list, reservation data, user data, weather data, any information which may predict a cart demand value, and/or any combination thereof may be used to determine a cart demand value. In this example, the cart demand value may be determined to be 65 carts.

The server(s) 102 may further determine whether the cart demand value is greater than the inventory of the plurality of carts during the future period of time by, for example, comparing the cart demand value (65 carts) to inventory of 45 carts at the service location 422. In another example, the server(s) 102 may determine whether the cart demand value is greater than the inventory of the plurality of carts based on the plurality of states (e.g., checked-in/checked-out state, reserved state, performance state, etc.) of the inventory of the plurality of carts. Subsequent to determining the cart demand value is greater than the inventory of the plurality of carts during the future period of time, the server(s) 102 may alert, via computing device 115c, service staff at the service location 422. In response, service staff may be able to prepare for the predicted cart demand by, for example, repairing carts with a performance state indicating the cart is non-functional, transfer one or more carts from service location 424, etc.

In some aspects, server(s) 102 may train a machine learning model with one or more of: (i) the electronic list, (ii) reservation data, (iii) user data, or (iv) weather data, to output a prediction or classification with respect to a cart demand value. For example, a machine learning model may be trained on reservation data and weather data to output a predicted cart demand value for a period of time. In this example, an ML module may be trained on reservation data and weather data as exemplary inputs and determined cart demand values as exemplary outputs. As described elsewhere herein, the ML module may generate a predictive function which maps cart demand values (outputs) to reservation data and weather data (inputs) and may utilize the predictive function to generate cart demand values (ML outputs) based upon the data inputs. In other examples, any combination of one or more of (i) the electronic list, (ii) reservation data, (iii) user data, or (iv) weather data may be used as inputs to an ML module, and associated cart demand values used as outputs to the ML module.

In some aspects, server(s) 102 may (1) determine a cart demand value for a future period of time based on one or more of (i) the electronic list, (ii) reservation data, (iii) user data, or (iv) weather data, (2) determine a service staff value for the future period of time based on one or more of (i) a quantity of service staff scheduled to work during the future period of time, (ii) a quantity of service staff on call to work during the future period of time, or (iii) service staff data, (3) determine whether a service capacity ratio exceeds a service capacity threshold, the service capacity ratio based on the cart demand value and the service staff value, and (4) responsive to determining the service capacity ratio exceeds the service capacity threshold, alert, via an electronic device, service staff.

A service staff value may indicate the number of service staff scheduled to staff the service location. For example, 10 individuals may be scheduled to work at the service location 422 from 12:00 pm to 10:00 pm, and the service staff value may be 10. In some aspects, the proficiency of a service staff may be standardized so that an adequately proficient individual service staff may be equivalent to one service staff, and a highly proficient individual service staff may be equivalent to e.g., 1.5 service staff. In these aspects, a service staff value may indicate the real proficiency of a service staff as a whole, such that a service staff value may or may not be equal to the number of service staff scheduled to staff a service location. For example, a service staff of 10 individuals may be scheduled to work from 8:00 am to 7:00 pm. The 10 service staff may include multiple highly proficient service staff and the service staff value may be 17. Additionally, or alternatively, a service staff value may indicate how many carts a service staff may be able to operate and/or ensure the operation of in e.g., a day. Accordingly, a service staff value may be based on (i) the quantity of service staff scheduled to work during the future period of time, (ii) a quantity of service staff on call to work during the future period of time (e.g., to fill in should a scheduled service staff be absent), and/or (iii) service staff data. Service staff data may include any data associated with a service staff e.g., individually, as a whole, etc. For example, service staff data may include how many hours a service staff worked, when they worked, performance reviews, etc. In these aspects, service staff data may include any data in relation to service staff described elsewhere herein. A cart demand value may be determined as described elsewhere herein.

Subsequent to determining a cart demand value and a staff service value, the server(s) 102 may determine whether a service capacity ratio exceeds a service capacity threshold. A service capacity ratio may indicate, for example, a ratio of the cart demand value to the service staff value. A service capacity threshold may be an acceptable service capacity ratio for a service location to operate properly. For example, the server(s) 102 may determine a cart demand value of 65 carts, and a service staff value (in this example indicating the number of carts the service staff may be able to operate and/or ensure the operation of from 8:00 am to 10:00 pm Jul. 4, 2023) of 60 carts. Accordingly, the service capacity ratio may be 65/60, or about 1.08. In this example, the service capacity threshold may be 1.05. The server(s) 102, subsequent to determining the service capacity ratio exceeds the service capacity threshold, may transmit an alert to computing device 115c via computing network 120 to alert service staff at service location 422 and/or operators that e.g., the service capacity ratio exceeds the service capacity threshold, insufficient service staff are scheduled, etc.

In some aspects, service staff data may include one or more of (i) time sheet data, (ii) availability data, (iii) customer survey data, (iv) performance review data, (v) reliability values, (vi) likeability values, or (vii) efficiency values. Time sheet data may indicate when one or more service staff clock-in for work, when one or more service staff leave clock-out, when one or more service staff are scheduled to clock-in, when one or more service staff are scheduled to clock-out, and/or any combination thereof. Availability data may indicate when one or more service staff are available and/or not available to work and/or be on call. Customer survey data may indicate the customer(s) experience interacting with one or more service staff. Customer survey data may, for example, indicate survey responses from customers (e.g., users) regarding the work performance of one or more service staff. Performance review data may indicate the manager(s) experience with one or more service staff as indicators to e.g., staff goodness. Performance review data may, for example, indicate performance reviews of one or more service staff done by service staff and/or superiors (e.g., managers) of service staff. Reliability values may indicate how reliable one or more service staff are to perform service staff responsibilities. For example, reliability values may indicate how reliable a service staff may be to show up to the service location 422 for work at the scheduled time. Likeability values may indicate how likeable one or more service staff is according to e.g., users, customers, managers, operators, service staff, third parties, etc. Likeability values may be based on, for example, survey data, online reviews, achievements and/or commendations, etc. Efficiency values may indicate how efficient of one or more service staff are at performing service staff responsibilities.

In some aspects, server(s) 102 may (1) determine a service staff score for an individual service staff of a plurality of service staff based on service staff data, (2) determine a combination of service staff which would cause the service capacity ratio to not exceed the service capacity threshold, (3) schedule the combination of service staff to work during the future period of time. A service staff score may indicate the proficiency, efficiency, and/or general ability of an individual service staff. In some aspects, the service staff score may indicate a proficiency, efficiency, and/or general ability of an individual service staff compared to a standardized adequately proficient, efficient, and/or able individual service staff. For example, a service staff score for an individual service staff may be 1.1 based on service staff data (e.g., performance review data, likeability values) indicating the individual service staff is adequately proficient and is more than adequately liked by customers (e.g., users).

In some aspects, a service staff value, as described elsewhere, may be based on service staff scores for multiple individual service staff. For example, a service staff value may be the combination of multiple service staff scores. In such aspects, the server(s) 102 may determine a combination of service staff (and thus their associated individual service staff scores) which would cause the service capacity ratio to not exceed the service capacity threshold. For example, the service capacity threshold may be equal to 1, and the service capacity ratio may be based on the cart demand value and the service staff value. The server(s) 102 may iteratively combine various service staff scores until a resultant service staff value is equal to the cart demand value, resulting in the service capacity ratio being equal to, and not exceeding the service capacity threshold. In such aspects, the server(s) 102 may schedule the combination of service staff (e.g., the service staff whose associated service staff scores were combined) to work during the future period of time. For example, the server(s) 102 may update service staff data, such as time sheet data, to include the combination of service staff as scheduled to clock in at the beginning of the period of time, and clock out at the end of the period of time. In various aspects, the combination of service staff may include service staff already scheduled to work during the period of time and/or staff not already scheduled to work during the period of time.

In some aspects, server(s) 102 may train, with the service staff data, a machine learning model configured to output a prediction or classification with respect to one or more of: (i) service staff values, (ii) reliability values, (iii) likeability values, (iv) efficiency values, (v) service staff scores, or (vi) combinations of service staff. For example, a machine learning model may be trained on service staff data to output service staff values.

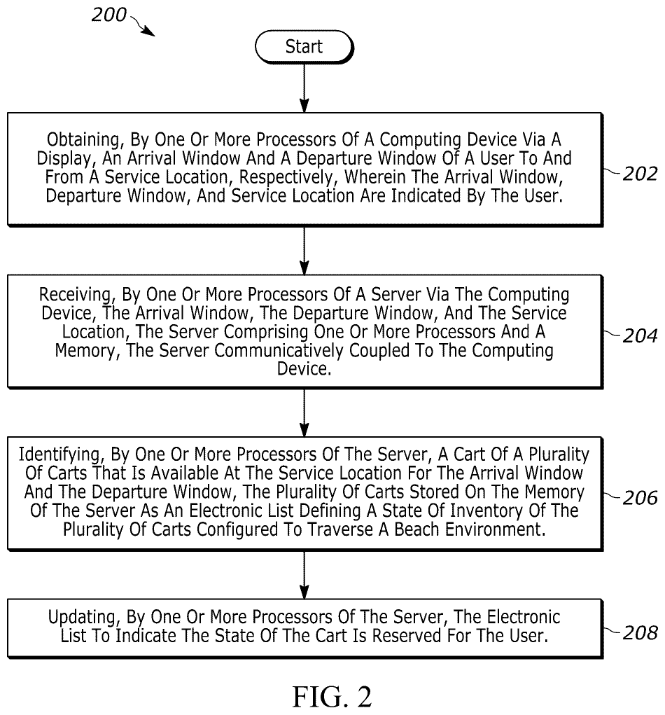

FIG. 2 illustrates an example cloud-based cart assistance method 200, in accordance with various aspects disclosed herein. At block 202, cloud-based cart assistance method 200 comprises obtaining, by one or more processors of a computing device via a display (e.g., such as a processor of user computing device 111c), an arrival window and a departure window of a user to and from a service location, respectively, wherein the arrival window, departure window, and service location are indicated by the user.

For example, in various aspects, a user may indicate, e.g., via a display device communicatively coupled to computing device 111c, an arrival window and a departure window of the user to and from a service location, as described further herein and in FIG. 3. Subsequently, the cart assistance app 108, executing on one or more processors of the computing device 111c, may obtain the arrival window and the departure window of the user to and from the service location as reservation data. The reservation data may then be used by the server(s) 102 to reserve the cart 130c for the user. Reservation data may be stored on the computing device 111c or the memory 106 of the server(s) 102.

With further reference to FIG. 2, at block 204, cloud-based cart assistance method 200 further comprises receiving, by one or more processors of a server (e.g., server(s) 102) via the computing device (e.g., computing device 111c), the arrival window, the departure window, and the service location, the server comprising one or more processors (e.g., processor(s) 104) and a memory (e.g., memory 106), the server communicatively coupled to the computing device.

At block 206, cloud-based cart assistance method 200 further comprises identifying, by one or more processors of the server, a cart (e.g., cart 130c) of a plurality of carts that is available at the service location for the arrival window and the departure window, the plurality of carts stored on the memory of the server as an electronic list defining a state of inventory of the plurality of carts configured to traverse a beach environment.

At block 208, cloud-based cart assistance method 200 further comprises updating, by one or more processors of the server, the electronic list to indicate the state of the cart is reserved for the user. In some aspects, the server(s) 102 may receive a maintenance signal from sensors (e.g., sensor(s) 133, maintenance sensor(s) 134) on the cart indicating cart performance metrics, and update the electronic list based on the maintenance signal, as described herein. For example, the server(s) 102 may receive a maintenance signal indicating the wheel 135 is missing from cart 130c and cart 130c is no longer functional. The server(s) 102 may update the electronic list based on the maintenance signal to indicate the cart 130c is no longer functional.

In some aspects, the state of a cart may define a performance state of the cart. In such aspects, the server(s) 102 may be configured to implement, or partially implement, one or more of: (i) alert, via an electronic device (e.g., computing device 115c), service staff when the performance state of a cart (e.g., cart 130c) indicates a cart is no longer functional; (ii) identify an available cart with a first performance state indicating the available cart is functional when a second performance state of a reserved cart indicates the reserved cart is no longer functional, and update the electronic list to indicate a change in the state of the available cart and the state of the reserved cart; and/or (iii) transmit, to an electronic device of the service staff, a performance report indicating the performance states of the plurality of carts.

For example, the cart 130c may have a broken wheel 135 and no longer function as a cart. In this example, a performance state of the cart 130c may indicate the cart 130c is no longer functional. The performance state may be updated by e.g., the server(s) 102 in response to receiving a maintenance signal, service staff and/or administrators via computing device 115c and/or terminal 109, etc. The server(s) 102 may subsequently alert service staff via computing device 115c of the performance state of cart 130c.

Additionally, or alternatively, cart 130c may be reserved for an arrival and/or departure window of a user; however, the performance state of the cart 130c may indicate the cart 130c is no longer functional. In such an example, the server(s) 102 may identify a cart (not shown) with a performance state indicating the cart is functional and available during the same arrival window and/or departure window of a reserved and non-functional cart 130c. The server(s) 102 may subsequently update the electronic list to indicate a change in the state of the cart 130c (e.g., from reserved to not reserved, from unavailable and functional to unavailable and non-functional, etc.) and/or a change in the state of the cart (not shown) (e.g., from not reserved to reserved). Additionally, or alternatively, server(s) 102 may transmit a performance report to service staff via computing device 115c indicating one or more performance states (e.g., updated performance states) of the plurality of carts (e.g., the cart 130c, cart (not shown)).

FIG. 3 illustrates an example graphic user interface (GUI) as rendered on a display screen 300 of a user computing device (e.g., user computing device 111c) regarding cart assistance in accordance with various aspects disclosed herein. For example, as shown in the example of FIG. 3, GUI 300 may be implemented or rendered by the cart assistance app (e.g., 108) on a display screen of a user computing device (e.g., user computing device 111c). For example, as shown in the example of FIG. 3, GUI 300 may be implemented or rendered via a native app executing on computing device 111c. In the example of FIG. 3, user computing device 111c is a computer device as described for FIG. 1, e.g., where 111c is illustrated as an APPLE IPHONE that implements the APPLE IOS operating system and that has a display screen. Computing device 111c may execute one or more native applications (apps) on its operating system, including, for example, the cart assistance app 108 as described herein. Such native apps may be implemented or coded (e.g., as computing instructions) in a computing language (e.g., SWIFT) executable by the user computing device operating system (e.g., APPLE iOS) by the processor of user computing device 111c. Additionally, or alternatively, GUI 300 may be implemented or rendered via a web interface, such as via a web browser application, e.g., Safari and/or Google Chrome app(s), or other such web browser or the like.

As illustrated for FIG. 3, a user may reserve a cart of a service location for assistance by indicating a service location, arrival window, and departure window. As shown for GUI portion 320 of GUI 300, cart reservation functionalities may be grouped for a user's convenience. Cart reservation functionalities may include GUI portion 324 to facilitate users indicating an arrival window, GUI portion 326 to facilitate users indicating a departure window, and/or GUI portion 322 to facilitate users indicating a service location. A user may indicate a service location via a service location GUI portion 322 of GUI 300 by clicking a service location 323a or service location 323b. In other aspects, a user may input an address into service location 322 to indicate a service location. In some aspects, a service location may be automatically indicated by a user via a preset service location. A user may indicate an arrival window via the arrival window GUI portion 324 by e.g., clicking, scrolling, selecting, and/or typing an arrival window 325. A user may indicate a departure window via the departure window GUI portion 326 by e.g., clicking, scrolling, selecting, and/or typing the departure window 327. By way of non-limiting example, such windows and time values may include, as shown for GUI portions 325 and 327, an arrival window beginning at 9:00 am Jun. 10, 2023 and ending at 9:30 am Jun. 10, 2023, and a departure window beginning at 1:00 pm Jun. 10, 2023 and ending at 1:30 pm Jun. 10, 2023. By providing windows of time, a user may indicate a period of time they may need assistance from a cart, and thus, indicate to e.g., the server(s) 102, the user may need a cart reserved.

As illustrated in a notification GUI portion 330 of GUI 300 in FIG. 3, a user may be notified and/or alerted of information regarding the cart. In the example illustration, GUI portion 330 may include, by way of non-limiting example, the notification “Please return cart to service location.” In this example, the user may have reserved a cart prior to an indicated arrival window, checked out the cart during the arrival window, and the departure window indicated by the user may have lapsed. In some aspects, the GUI portion 330 may include an alert to a user the service is ending (e.g., departure window is about to lapse and/or has lapsed), alert service staff that service for the user is ending, and/or a third-party that service for the user is ending. Additionally, or alternatively, GUI portion 330 may include any alert and/or notification as described elsewhere herein. Furthermore, alerting the user, service staff, and/or a third party that service for the user is ending is exemplary, and in some aspects, the server(s) 102 may alert the user, service staff, and/or a third party that service for the user is ending via e.g., a phone call, push notification, etc., and not via the GUI 300.

In some aspects, an application programming interface (API) may be configured to allow a third-party to access the API and act in place of the user. For example, a user may be staying at a hotel and the hotel service staff may reserve cart 130c for the user by accessing an API, as described herein. Continuing this example, the hotel service staff may receive an alert that service for the user is ending via an electronic device and/or the API.

As further illustrated in an association GUI portion 340 of GUI 300 in FIG. 3, a user may initiate association of a cart with the user. In some aspects, a cart (e.g., cart 130c) may be associated with a two-dimensional (2D) barcode (e.g., 2D barcode 136) and the server(s) 102 may obtain an image containing the 2D barcode to establish an association between the 2D barcode (and thus the associated cart) and a user-specific code associated with the user. A user may initiate association of a cart by clicking GUI portion 340. The user computing device (e.g., 111c) and/or the server(s) 102 may obtain an image including a 2D barcode (e.g., barcode 136) from an image capture device, as described herein. The server(s) 102 may subsequently establish an association between the 2D barcode and a user-specific code associated with the user. The server(s) 102 may obtain the user-specific code from the user computing device comprising the image capture device. In some aspects, the system may determine a geographic location of a cart based on the 2D barcode and a current geographic location of the user. Continuing the previous example, the server(s) 102 may obtain the current geographic location of the user from the computing device 111c and determine the geographic location of the cart 130c based on the 2D barcode and a current geographic location of the user determined from the user-specific code. Accordingly, by clicking GUI portion 340, the user may enable the cart 130c to be picked up at the user's current geographic location, as described herein.

In some aspects, a user may indicate to server(s) 102 the cart is ready to be picked-up e.g., from the user's current geolocation, by clicking the GUI portion 350 which includes by way of non-limiting example, “Ready for Pickup.” For example, a user may have unpacked their items off of the cart 130c and no longer need the cart 130c. The user may click GUI portion 350, indicating the cart 130c is ready to be picked up (e.g., by service staff of a service location). In some aspects, the service staff may be notified of a geolocation of the cart based on the current geolocation of the user and/or the current geolocation of the user when the user requested the cart to be picked-up e.g., by clicking GUI portion 350. the geolocation of the cart may be determined

In some aspects, a cart may be autonomous. For example, the cart 130c may be capable of independently traversing a beach environment without a user and/or service location staff moving the cart 130c. In such aspects, a user may indicate for an autonomous cart to travel to the service location by clicking GUI portion 360, as described elsewhere herein. Similarly, a user may indicate to an autonomous cart to travel to the current geographic location of the user by clicking GUI portion 370, as described elsewhere herein.

In some aspects, a cart may be semi-autonomous and be capable of traversing a beach environment by following a user. Accordingly, a user may indicate to a semi-autonomous cart to follow the user by clicking GUI portion 380, as described elsewhere herein.

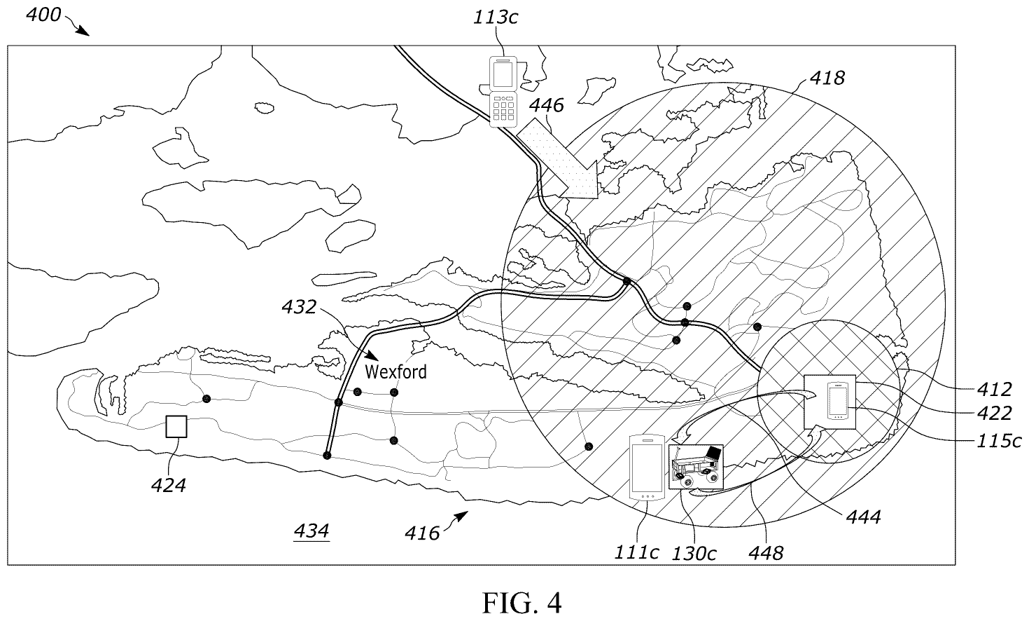

FIG. 4 illustrates an exemplary implementation 400 of a cloud-based cart assistance system, in accordance with various aspects disclosed herein. In general, FIG. 4 illustrates user computing devices 111c, 113c, 115c and cart 130c entering, exiting, and/or remaining within perimeters of a geographic area. Specifically, FIG. 4 illustrates an island 432, a body of water 434, a coastline 416, a service location 422, a service location 424, the computing device 115c used by service staff at service location 422, the computing device 111c of a first user, the computing device 113c of a second user, the cart 130c, a perimeter 412 surrounding the service location 422, a perimeter 418 further surrounding the perimeter 412, an arrow 444 illustrating a movement of the computing device 111c and/or the cart 130c from the service location 422 to the coastline 416, and an arrow 448 illustrating a movement of the computing device 113c from outside the perimeter 418 to inside the perimeter 418.

In various aspects, one or more service locations may provide cart assistance for users. Accordingly, a user may indicate a service location at which they may arrive to within the arrival window and/or depart from within the departure window, as shown in FIG. 3. In reference to FIG. 4, a user may indicate an arrival window and departure window to and from service location 422 instead of service location 424. In some aspects, service staff (e.g., service staff supporting operations of service location 422) may or may not be physically present at a service location (e.g., 422). For example, service staff may support operations of one or more service locations remotely.

In some aspects, the state of a cart may be based on the geographic location of the cart, wherein the state of the cart is updated (e.g., by server(s) 102) to a checked-out state when the geographic location of the cart is not at the service location. For example, FIG. 4 illustrates cart 130c outside of the service location 422. In this example, server(s) 102 may update the state of the cart to a checked-out state based on the geographic location of the cart.

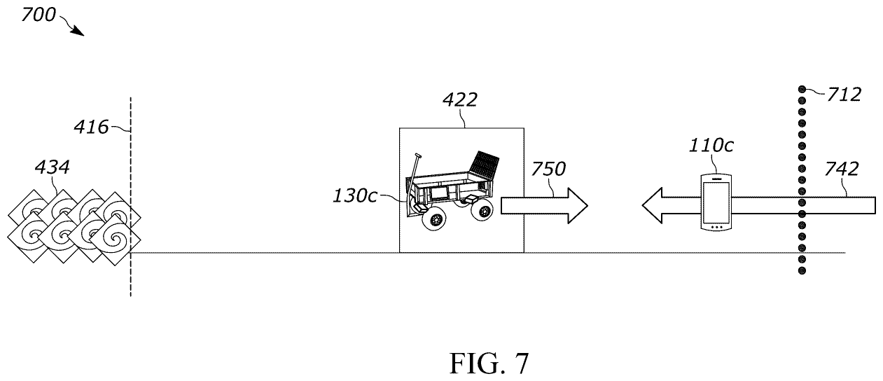

FIG. 4 further illustrates service location 422 and computing device 115c circumscribed by perimeter 412. In some aspects, a perimeter, such as perimeter 412, 418, 712 (discussed in FIG. 7), may be a virtual boundary, such as a geofence, responsive to users being within the virtual boundary, outside of the virtual boundary, and/or a change in either (i.e., a user entering or exiting the virtual boundary). As described herein, a perimeter may be GPS-based (established based off the GPS location and/or associated GPS location of e.g., a user), Wi-Fi-based (established based on triangulation of signal strengths a computing device and/or electronic device has to multiple Wi-Fi access points), cellular-based (established based on triangulation of signal strengths to cellular base stations), based on another form of wireless communication, and/or a combination of wireless communication-based techniques. Additionally, as used herein, the terms “first perimeter,” “second perimeter,” “third perimeter,” “fourth perimeter,” and “fifth perimeter,” may be used interchangeably.

Further, the exemplary perimeter 412 is illustrated as circular; however, a perimeter (e.g., 412, 418) may be any shape (e.g., centroid, polygonal, etc.) or line, such as the coastline 416. In some aspects, the state of the cart is updated to the checked-out state when the geographic location of the cart is at or near a third perimeter comprising a coastline (e.g., coastline 416) of a body of water (e.g., body of water 434), and wherein the service location (e.g., service location 422) is inland (e.g., inland of island 432) from the coastline. For example, when the cart 130c is not at service location 422, and the server(s) 102 update the state of the cart 130c to a checked-out state based on the cart 130c being at or near the coastline 426 of body of water 434, a second user (e.g., user using computing device 113c) will be prevented from reserving the checked-out (and thus unavailable) cart 130c. In other words, the server(s) 102 will be able to maintain an up-to-date electronic list and states of the plurality of carts.

In some aspects, the geographic location of the cart (e.g., 130c) is determined by a current geographic location of the user (not shown). For example, the cart 130c may not include instruments capable of determining the cart's 130c geographic location; however, a user may be associated with the cart 130c after checking-out the cart 130c from the service center 422. Additionally, the computing device 111c may be associated with the user and may include instruments capable of transmitting the current geolocation of the computing device 111c (and thus the user) to the server(s) 102. The server(s) 102 may subsequently determine the geographic location of the cart 130c by the current geographic location of the user.

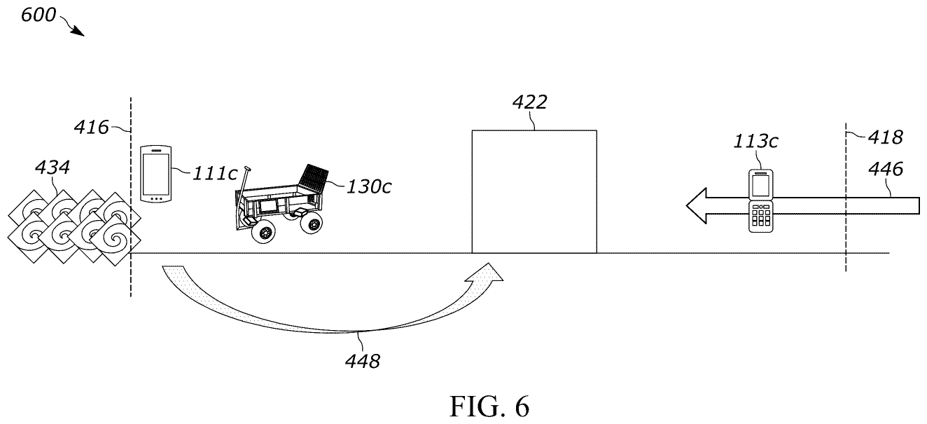

FIG. 4 further illustrates computing device 113c moving along arrow 446 and past perimeter 418. In some aspects, the server(s) 102 may obtain a current geographic location of a second user (e.g., a second user using computing device 113c) and notify a user (e.g., a user using computing device 111c) to return the cart to the service location (e.g., 422) when the current geographic location of the second user is within a fourth perimeter (e.g., perimeter 418). This and further aspects are discussed further in FIG. 6.

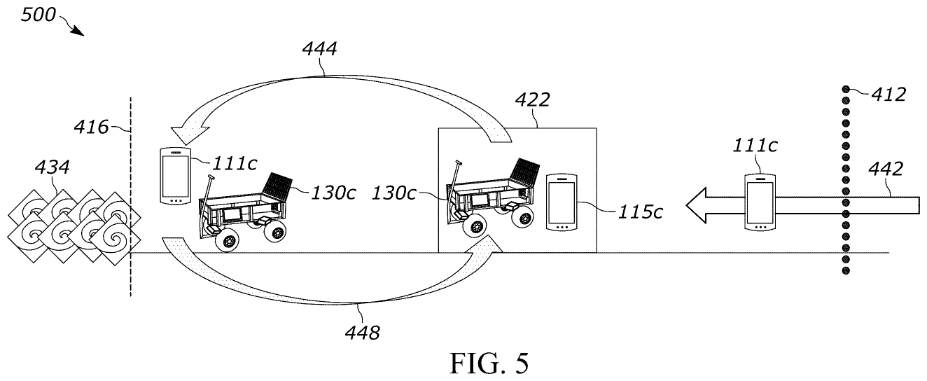

FIG. 4 further illustrates computing device 115c at service location 422. In some aspects, service staff at a service location (e.g., 422) may be notified of information regarding cart assistance via a display device (e.g., computing device 115c), as described further in FIG. 5.

FIG. 5 illustrates an exemplary implementation 500 of a cloud-based cart assistance system, in accordance with various aspects disclosed herein. In general, FIG. 5 illustrates some aspects of the cloud-based cart assistance system for a single user from before a user is assisted by a cart, while a user is assisted by a cart, and after a user has been assisted by a cart.

Specifically, FIG. 5 illustrates the computing device 111c moving towards service location 422 and passing perimeter 412 via the path of the arrow 442. FIG. 5 further illustrates the computing device 111c and/or cart 130c moving away from the service location 422 towards the coastline 416 and body of water 434 via the path of arrow 444 and, subsequently, the computing device 111c and/or cart 130c returning to the service location 422 via the path of arrow 448. FIG. 5 further illustrates computing device 115c at the service location 422.

In some aspects, the server(s) 102 may obtain a current geographic location of a user, transmit the current geographic location of the user to the server, and update, by the server (e.g., server(s) 102), the electronic list to indicate that the cart is reserved for the user when the current geographic location of the user is within a first perimeter (e.g., perimeter 412, 418) of the service location. For example, a user may be associated with the computing service 111c, which may include the cart assistance app 108, GPS capable instruments, and wireless communication 122 capabilities as described elsewhere herein. The cart assistance app 108 may obtain a current geographic location of the computing device 111c (and thus the associated user) via the GPS instruments and transmit the current geographic location of the user to the server(s) 102. The current geolocation of the user may be stored on the memory of computing device 111c and/or memory 106 of the server(s) 102. When the current geolocation is within e.g., perimeter 412, and thus nearing the service location 422, the server(s) 102 may update the electronic list to indicate the cart 130c is reserved for the user. As described in FIG. 4, the perimeter may be a customizable virtual boundary, and is not limited to the shape or location of perimeter 412. For example, the location of perimeter 412 may be customizable by service staff at the service location 422 via the computing device 115c, and/or by an administrator/operator via terminal 109.

In some aspects, the server(s) 102 may obtain a current geographic location of an electronic device of the user, transmit the current geographic location of the user to the server, and notify, via a display device, service staff at the service location when the current geographic location of the electronic device of the user is within a second perimeter of the service location. For example, a user may be associated with the computing device 111c, which may be an IPHONE capable of determining the IPHONE's current geographic location and executing the app computing instructions of the cart assistance app 108. When the current geolocation is within e.g., perimeter 412, and thus nearing the service location 422, the server(s) 102 may notify, via computing device 115c, service staff at the service location 422 that the location of computing device 111c is within the perimeter 412. In this example, service staff may be able to anticipate the user's arrival and ensure the appropriate number of carts desired by the user are ready for the user's arrival.

Similarly, in some aspects, service staff at a service location may be notified via a display device (e.g., computing device 115c) when the arrival window of a user is about to lapse in a given amount of time and/or when the departure window of a user is about to lapse in a given amount of time. For example, an arrival window for a user may be between 9:00 am and 9:30 am, and a departure window for the user may be between 1:00 pm and 1:30 pm, as illustrated in FIG. 3. At 8:30 am, service staff at service location 422 may be notified via computing device 115c that the arrival window of a user will lapse at 9:00, when the given amount of time is 30 minutes. Additionally, or alternatively, at 8:30 am, service staff at service location 422 may be notified via computing device 115c that the arrival window of a user will lapse at 9:30, when the given amount of time is 60 minutes. Accordingly, any time within a window of time (e.g., arrival window, departure window) may be the time at which a window of time will lapse, and any length of time may be set as the given amount of time for which service staff should be notified before a lapse occurs. In some aspects, service staff and/or administrators may set the given amount of time via an electronic device (e.g., computing device 115c) and/or terminal 109.

In some aspects, wherein a state of a cart is updated to a checked-out state, a cart assistance app (e.g., cart assistance app 108) may notify the user to return the cart to a service location when a departure window of the user is about to lapse in a given amount of time. For example, in reference to FIG. 5, a user may be proximate to the coastline 416 with their ANDROID cellphone (computing device 111c) and the cart 130c. The departure window of the user may be 1:00 pm and at 12:45 pm the user may receive a notification via the computing device 111c informing the user to return the cart 130c to service location 422. In this example the given amount of time is 15 minutes. The notification via the computing device 111c may be e.g., a phone call from service staff, an administrator, third-party, and/or computer-generated voice, a text message, a push notification to the computing device 111c via the cart assistance app 108, and/or any combination thereof. Further, any notification and/or alert as described herein may be similarly communicated to a user and/or computing device.

In some aspects, the server(s) 102 may receive a signal from a user indicating the user is ready for the cart to be picked up by service staff; and notify, via a display device, service staff the user is ready for the cart to be picked up at a geographic location of the cart. For example, a user associated with computing device 111c may unload their beach-day supplies from the cart 130c after reaching the coastline 416. The user may subsequently indicate the cart is ready for pickup by clicking GUI portion 350 of GUI 300, as described in FIG. 3. Clicking GUI portion 350 may cause cart assistance app 108 to generate and transmit a signal to be received by server(s) 102. Subsequent to receiving the signal, the server(s) 102 may determine and/or obtain the geolocation of the cart from e.g., database 105, memory 106, and notify service staff at the service location 422 via the computing device 115c the user is ready for the cart 130c to be picked up at the geolocation of the cart 130c. In some aspects, the signal may include geolocation data of the computing device 111c indicating the current geolocation of the user. In some aspects, the cart assistance app 108 may periodically (e.g., every minute, every 10 minutes, when the rate of change in geolocation is less than a threshold rate, such as 5 feet per minute, when geolocations cluster within a threshold distance of the other, such as 2 feet, etc.) transmit geolocation data to the server(s) 102. In some aspects, the server(s) 102 may determine the geolocation of the cart 130c based on the geolocation of the user and/or computing device 111c. In some aspects, the service staff notified may the service staff of the service location closest to the geolocation of the cart.

In a similar example, a user may indicate cart is ready to be picked up after having used the cart 130c to transfer their beach-day supplies to their car (not shown) parked by the service location 422.

In some aspects, wherein a cart is semi-autonomous, a cart assistance app (e.g., cart assistance app 108) computing instructions, when executed by one or more processors, may cause the one or more processors to communicate with sensors on the cart, thereby causing the cart to follow the user. For example, cart 130c may include sensors 133 for wireless communication 125 with the computing device 111c of the user, as described in FIG. 1. Additionally, or alternatively, the cart 130c may include sensors 133 for wireless communication 124 with server(s) 102. In reference to FIG. 5, the cart 130c may follow the computing device 111c (and thus the user) from the service location 422, along the arrow 444, and to the coastline 416, via BLUETOOTH wireless communication 125 indicating the movements of the user. A user may initiate the cart 130c following the user by, for example, clicking GUI portion 380 of GUI 300, as described in FIG. 3. The user may additionally, or alternatively, initiate the cart 130c to follow the user to and from any destination, including from the coastline 416, along the arrow 448, and to the service station 422.

In some aspects, the cart 130c may include a display device (e.g., display device 131) and a user may initiate the cart 130c to follow the user via the display device. In some aspects, including these, the cart may follow the user by wireless communication 125 with the computing device of the user via sensor(s) 133. In some aspects, the cart (e.g., 130c) may follow a user via image recognition techniques via processing images from an image capture device (not shown).

In some aspects, wherein the cart is autonomous, the server(s) 102 may receive a signal from an electronic device of the user indicating for the cart to return to the service location, and communicate with sensors on the cart, thereby causing the cart to autonomously return to the service location. For example, the user may click GUI portion 360 of GUI 300 to indicate the cart 130c to return to service location 422. The cart assistance app 108, may subsequently send a signal via communication 122 to server(s) 102. The server(s) 102 may subsequently communicate with sensors 133 via communication 122 and the cart 130c may return to the service location 422.

In some aspects, the electronic device may be the computing device 111c and/or the display device 131 of cart 130c. For example, the user may indicate on the display device 131 when the user no longer needs assistance from the cart 130c, and the cart may return to service location 422. In an additional, or alternative, example, the user may click GUI portion 360 of GUI 300 to indicate the cart to return to service location 422. The cart assistance app 108, may subsequently send a signal via communication 125 to the cart 130c thereby causing the cart to return to service station 422.

In some aspects, wherein the cart is autonomous, the server(s) 102 may receive a signal from an electronic device (e.g., computing device 111c) of the user indicating the cart (e.g., cart 130c) to return to a current geographic location of the user, obtain a current geographic location from an electronic device of the user, and communicate with sensors (e.g., sensors 133) on the cart, thereby causing the cart to autonomously travel to the current geographic location of the user. For example, the user may click GUI portion 370 of GUI 300 to indicate the cart 130c to return a current geographic location of the user. The cart assistance app 108, may subsequently send a signal via communication 122 to server(s) 102. The signal may include current geolocation data (e.g., GPS coordinates) indicating the current geolocation of the user and/or the serve(s) 102, upon receiving the signal, may obtain current geolocation data from the computing device 111c. The server(s) 102 may subsequently communicate with sensors 133 via communication 122 to indicate the current geographic location of the user for the cart 130c to travel to autonomously, thereby causing the cart 130c to return to the current geographic location of the user.

FIG. 6 illustrates an exemplary implementation 600 of a cloud-based cart assistance system, in accordance with various aspects disclosed herein. In general, FIG. 6 illustrates some aspects of the cloud-based cart assistance system for two users. Specifically, FIG. 6 illustrates the computing device 113c moving towards service location 422 and passing perimeter 418 via the path of the arrow 446. FIG. 6 further illustrates the computing device 111c and/or cart 130c returning to the service location 422 via the path of arrow 448.

In some aspects, wherein the state of a cart (e.g., 130c) is updated to a checked-out state, the server(s) 102 may obtain a current geographic location of a second user (e.g., user using computing device 113c) and notify, via a display device (e.g., computing device 111c, display device 131 of the cart 130c), the user to return the cart to the service location when the current geographic location of the second user is within a fourth perimeter. For example, a user with computing device 111c may be using the cart 130c at the coastline 416, as illustrated in FIG. 6, and the state of the cart 130c may accordingly be updated to a checked-out state by server(s) 102. However, a second user with computing device 113c may additionally require the assistance of cart 130c to reach the coastline 416. Accordingly, the server(s) 102 may obtain the current geographic location from the computing device 113c one or more times and, when the current geographic location is within the perimeter 418, may notify the user via GUI portion 330 of GUI 300 on computing device 111c to return the cart 130c to the service location 422. In some aspects, a cart assistance app of a computing device (e.g., 111c, 113c) may transmit a signal to the server(s) 102 when the current geolocation of the computing device is within a perimeter.

As discussed elsewhere herein, a perimeter, such as perimeter 418 illustrated in FIG. 6, is an arbitrary virtual boundary customizable to best suit the use of the present techniques by a user (e.g., beachgoer, service location staff, administrator, third-party, hotel hospitality staff, etc.). For example, perimeter 418 may be the same, or similar size as perimeter 412. Specifically, the perimeter 418 may be adjusted to a distance which may cause, for example, the time a second user drives from the perimeter 418 to the service location 422 to equal the time a user and/or autonomous cart 130c walks/traverses the distance of the coastline 416 to the service location 422.

FIG. 7 illustrates an exemplary implementation 700 of a cloud-based cart assistance system, in accordance with various aspects disclosed herein. In general, FIG. 7 illustrates some aspects of the cloud-based cart assistance system for one user and an autonomous cart. Specifically, FIG. 7 illustrates the cart 130c moving towards the computing device 111c via the path of an arrow 750, and computing device 111c moving towards the service location 422 and passing a perimeter 712 via the path of an arrow 742.

In some aspects, wherein the cart is autonomous, the server(s) 102 may obtain a current geographic location of an electronic device (e.g., computing device 111c) of the user, and communicate with sensors (e.g., sensor(s) 133) on the cart when the current geographic location of the electronic device of the user is within a fifth perimeter of the service location, thereby causing the cart to autonomously travel to the current geographic location of the electronic device of the user. For example, server(s) 102 may obtain the current geographic location of the computing device 111c of the user and when the current geographic location is within the perimeter 712, the server(s) 102 may subsequently communicate with the cart 130c via the sensors 133, thereby causing the cart 130c to autonomously travel to the current geographic location of the cart. One of ordinary skill in the art may appreciate how this aspect may be repeated multiple times until, for example, the cart reaches the user, and may cause the cart to autonomously travel to the user regardless of if the user is moving or remaining in one location. In some aspects, the server(s) 102 may communicate with sensors on the cart when the current geographic location of the electronic device of the user is within a fifth perimeter of the service location, thereby causing the cart to autonomously travel to a given geolocation. For example, when the computing device 111c (and thus the user) is within the perimeter 712 the cart 130c may travel to the geolocation of a specified parking space (not shown) the user is expected (and/or instructed) to park at.

In some aspects, wherein the cart (e.g., cart 130c) is autonomous or semi-autonomous and sensors (e.g., sensor(s) 133, maintenance sensor(s) 134) affixed to the cart are powered by a battery (not shown) charged by a plurality of solar panels (e.g., solar panel 132), server(s) 102 may (1) determine solar condition requirements for a cart to operate during a period of time, (2) determine whether solar condition forecasts of the period of time do not meet the solar condition requirements, and (3) responsive to determining solar condition forecasts of the period of time do not meet the solar condition requirements, alert, via an electronic device, service staff to charge the battery via an external power source. For example, the solar panel 132 may be configured to output sufficient electrical output for the autonomous cart 130c, as shown in FIG. 7, to provide 14 hours of assistance if the solar panel 132 is in full sun (ideal solar conditions) for 8 hours. However, ideal solar conditions for the solar panel 132 to provide sufficient operational power may not happen every day and/or be consistent all day long, such as when days have a low Ultraviolet (UV) index (e.g., <3), a cloudy sky, etc. Further, the cart 130c may have varying power reserves for operation (e.g., a battery 2%, 50%, or 98% charged). Accordingly, the server(s) 102 may determine a solar condition requirement for the cart 130c to operate during a period of time. In this example, the power reserves may be at 50% and cart 130c may require 4 hours of full sun to operate from 8:00 am to 10:00 pm (i.e., period of time). In some examples, the period of time may be the time in between a user's arrival window and departure window.

The server(s) 102 may subsequently determine whether solar condition forecasts for 8:00 am to 10:00 pm do or do not meet the determined solar condition requirements. In this example, the weather for the period of time may be partly cloudy and the solar condition forecast may be poor. The server(s) 102 may obtain a solar condition forecast via an external server (not shown), the cart assistance app 108, the database 105, the terminal 109, and/or any combination thereof. The server(s) 102 may determine whether the solar condition forecast meets the solar condition requirements by comparing the solar condition requirements and the solar condition forecast. In this example, the server(s) 102 may determine the solar condition forecast of the period of time do not meet the solar condition requirements, and subsequently alert, via the computing device 115c, service staff to charge the battery via an external power source, such as a 120 volt outlet.

In some examples, the cart 130c may require different amounts of power to operate, which may depend on e.g., the number of electrical components requiring power (e.g., a display device, a maintenance sensor), whether the cart 130c is manually operated, semi-autonomous, or autonomous, the age of the electrical components, the terrain the cart 130c is configured to traverse, the amount of charge in a battery, etc.

### Additional Considerations

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A cloud-based cart assistance system, the cart assistance system comprising:
a cart assistance application (app) comprising app computing instructions configured to execute on one or more processors of a computing device, wherein the app computing instructions, when executed by the one or more processors of the computing device, cause the one or more processors to:
obtain, from a display of the computing device, an arrival window and a departure window of a user to and from a service location, respectively, wherein the arrival window, departure window, and service location are indicated by the user, and
a server communicatively coupled to the cart assistance app, the server comprising one or more processors and a memory, the memory storing a state of an inventory of a plurality of carts configured to traverse a beach environment, the memory storing server computing instructions configured to execute on the one or more processors of the server, wherein the server computing instructions, when executed by the one or more processors of the computing device, cause the one or more processors of the server to:
receive, from the computing device, the arrival window, the departure window, and the service location,
identify a cart of the plurality of carts that is available at the service location for the arrival window and the departure window, and
update an electronic list to indicate the state of the cart is reserved for the user.

2. The cloud-based cart assistance system of claim 1, wherein the app computing instructions, when executed by the one or more processors, further cause the one or more processors to:
obtain a current geographic location of the user,
transmit the current geographic location of the user to the server, and
update, by the server, the electronic list to indicate that the cart is reserved for the user when the current geographic location of the user is within a first perimeter of the service location.

3. The cloud-based cart assistance system of claim 1, wherein the app computing instructions, when executed by the one or more processors, further cause the one or more processors to:
obtain a current geographic location of an electronic device of the user,
transmit the current geographic location of the user to the server, and
notify, via a display device, service staff at the service location when the current geographic location of the electronic device of the user is within a second perimeter of the service location.

4. The cloud-based cart assistance system of claim 1, wherein the server computing instructions, when executed by the one or more processors, further cause the one or more processors to do one or more of:
(i) notify, via a display device, service staff at the service location the arrival window of the user is about to lapse in a given amount of time, and/or
(ii) notify, via a display device, service staff at the service location the departure window of the user is about to lapse in a given amount of time.

5. The cloud-based cart assistance system of claim 1, wherein the server computing instructions, when executed by the one or more processors, further cause the one or more processors to:
determine the state of the cart based on a geographic location of the cart, wherein the state of the cart is updated to a checked-out state when the geographic location of the cart is not at the service location.

6. The cloud-based cart assistance system of claim 5, wherein the state of the cart is updated to the checked-out state when the geographic location of the cart is at or near a third perimeter comprising a coastline of a body of water, and wherein the service location is inland from the coastline.

7. The cloud-based cart assistance system of claim 5, wherein the geographic location of the cart is determined by a current geographic location of the user.

8. The cloud-based cart assistance system of claim 1, wherein the state of the cart is updated to a checked-out state, and wherein the app computing instructions, when executed by the one or more processors, further cause the one or more processors to:
notify the user to return the cart to the service location when the departure window of the user is about to lapse in a given amount of time.

9. The cloud-based cart assistance system of claim 1, wherein the state of the cart is updated to a checked-out state, and wherein the server computing instructions, when executed by the one or more processors, further cause the one or more processors to:
obtain a current geographic location of a second user, and
notify, via a display device, the user to return the cart to the service location when the current geographic location of the second user is within a fourth perimeter.

10. The cloud-based cart assistance system of claim 1, wherein the server computing instructions, when executed by the one or more processors, further cause the one or more processors to:
receive a signal from the user indicating the user is ready for the cart to be picked up by service staff; and
notify, via a display device, service staff the user is ready for the cart to be picked up at a geographic location of the cart.

11. The cloud-based cart assistance system of claim 1, further comprising:
an application programming interface (API) configured to allow a third-party to access the API and act in place of the user.

12. The cloud-based cart assistance system of claim 1, wherein the server computing instructions, when executed by the one or more processors, further cause the one or more processors to do one or more of:
(i) alert, via an electronic device, the user that service is ending,
(ii) alert, via an electronic device, service staff that service for the user is ending, and/or
(iii) alert, via an electronic device, a third-party that service for the user is ending.

13. The cloud-based cart assistance system of claim 1, wherein the cart is associated with a two-dimensional barcode (2D barcode), including a unique universal product code (UPC) or a quick response (QR) code, and wherein the server computing instructions, when executed by the one or more processors, further cause the one or more processors to:
obtain an image from an imaging device of the user, the image containing the 2D barcode,
establish an association between the 2D barcode and a user-specific code associated with the user, and
determine a geographic location of the cart based on the 2D barcode and a current geographic location of the user determined from the user-specific code.

14. The cloud-based cart assistance system of claim 1, wherein the cart is semi-autonomous, and wherein the app computing instructions, when executed by the one or more processors, further cause the one or more processors to:
communicate with sensors on the cart, thereby causing the cart to follow the user.

15. The cloud-based cart assistance system of claim 1, wherein the cart is autonomous, and wherein the server computing instructions, when executed by the one or more processors, further cause the one or more processors to:
obtain a current geographic location of an electronic device of the user, and
communicate with sensors on the cart when the current geographic location of the electronic device of the user is within a fifth perimeter of the service location, thereby causing the cart to autonomously travel to the current geographic location of the electronic device of the user.

16. The cloud-based cart assistance system of claim 1, wherein the cart is autonomous, and wherein the server computing instructions, when executed by the one or more processors, further cause the one or more processors to:
receive a signal from an electronic device of the user indicating for the cart to return to the service location, and
communicate with sensors on the cart, thereby causing the cart to autonomously travel to the service location.

17. The cloud-based cart assistance system of claim 1, wherein the cart is autonomous, and wherein the server computing instructions, when executed by the one or more processors, further cause the one or more processors to:
receive a signal from an electronic device of the user indicating the cart to return to a current geographic location of the user,
obtain a current geographic location from an electronic device of the user, and
communicate with sensors on the cart, thereby causing the cart to autonomously travel to the current geographic location of the user.

18. The cloud-based cart assistance system of claim 1, wherein the server computing instructions, when executed by the one or more processors, further cause the one or more processors to:
receive a maintenance signal from sensors on the cart indicating cart performance metrics, and
update the electronic list based on the maintenance signal.

19. The cloud-based cart assistance system of claim 1, wherein the state of a cart further defines a performance state of the cart, and wherein the server computing instructions, when executed by the one or more processors, further cause the one or more processors to do one or more of:
(i) alert, via an electronic device, service staff when the performance state of a cart indicates the cart is no longer functional;
(ii) identify an available cart with a first performance state indicating the available cart is functional when a second performance state of a reserved cart indicates the reserved cart is no longer functional, and
update the electronic list to indicate a change in the state of the available cart and the state of the reserved cart; or
(iii) transmit, to an electronic device of the service staff, a performance report indicating the performance states of the plurality of carts.

20. The cloud-based cart assistance system of claim 1, wherein the server computing instructions, when executed by the one or more processors, further cause the one or more processors to:
determine a cart demand value for a future period of time based on one or more of (i) the electronic list, (ii) reservation data, (iii) user data, or (iv) weather data,
determine whether the cart demand value is greater than the inventory of the plurality of carts during the future period of time, and
responsive to determining the cart demand value is greater than the inventory of the plurality of carts during the future period of time, alert, via an electronic device, service staff.

21. The cloud-based cart assistance system of claim 1, wherein the server computing instructions, when executed by the one or more processors, further cause the one or more processors to:
determine a cart demand value for a future period of time based on one or more of (i) the electronic list, (ii) reservation data, (iii) user data, or (iv) weather data,
determine a service staff value for the future period of time based on one or more of (i) a quantity of service staff scheduled to work during the future period of time, (ii) a quantity of service staff on call to work during the future period of time, or (iii) service staff data,
determine whether a service capacity ratio exceeds a service capacity threshold, the service capacity ratio based on the cart demand value and the service staff value, and
responsive to determining the service capacity ratio exceeds the service capacity threshold, alert, via an electronic device, service staff.

22. The cloud-based cart assistance system of claim 21, wherein service staff data includes one or more of (i) time sheet data, (ii) availability data, (iii) customer survey data, (iv) performance review data, (v) reliability values, (vi) likeability values, or (vii) efficiency values, and wherein the server computing instructions, when executed by the one or more processors, further cause the one or more processors to:
determine a service staff score for an individual service staff of a plurality of service staff based on service staff data,
determine a combination of service staff which would cause the service capacity ratio to not exceed the service capacity threshold,
schedule the combination of service staff to work during the future period of time.

23. The cloud-based cart assistance system of claim 22, wherein the server computing instructions, when executed by the one or more processors, further cause the one or more processors to:
train, with the service staff data, a machine learning model configured to output a prediction or classification with respect to one or more of: (i) service staff values, (ii) reliability values, (iii) likeability values, (iv) efficiency values, (v) service staff scores, or (vi) combinations of service staff.

24. The cloud-based cart assistance system of claim 1, wherein the server computing instructions, when executed by the one or more processors, further cause the one or more processors to:
train, with one or more of (i) the electronic list, (ii) reservation data, (iii) user data, or (iv) weather data, a machine learning model configured to output a prediction or classification with respect to a cart demand value.

25. The cloud-based cart assistance system of claim 1, wherein the cart is autonomous or semi-autonomous and sensors affixed to the cart are powered by a battery charged by a plurality of solar panels, and wherein the server computing instructions, when executed by the one or more processors, further cause the one or more processors to:
determine solar condition requirements for a cart to operate during a period of time,
determine whether solar condition forecasts of the period of time do not meet the solar condition requirements, and
responsive to determining solar condition forecasts of the period of time do not meet the solar condition requirements, alert, via an electronic device, service staff to charge the battery via an external power source.

26. A cloud-based cart assistance method comprising:
obtaining, by one or more processors of a computing device via a display, an arrival window and a departure window of a user to and from a service location, respectively, wherein the arrival window, departure window, and service location are indicated by the user;
receiving, by one or more processors of a server via the computing device, the arrival window, the departure window, and the service location from the computing device, the server comprising one or more processors and a memory, the server communicatively coupled to the computing device;
identifying, by one or more processors of the server, a cart of a plurality of carts that is available at the service location for the arrival window and the departure window, the plurality of carts stored on the memory of the server as an electronic list defining a state of inventory of the plurality of carts configured to traverse a beach environment; and
updating, by one or more processors of the server, the electronic list to indicate the state of the cart is reserved for the user.

27. The cloud-based cart assistance method of claim 26, further comprising:
obtaining, by one or more processors of the computing device, a current geographic location of the user;
transmitting, by one or more processors of the computing device, the current geographic location of the user to the server; and
updating, by one or more processors of the server, the electronic list to indicate that the cart is reserved for the user when the current geographic location of the user is within a first perimeter of the service location.

28. The cloud-based cart assistance method of claim 26, further comprising:
obtaining, by one or more processors of the computing device, a current geographic location of an electronic device of the user,
transmitting, by one or more processors of the computing device, the current geographic location of the user to the server; and
notifying, via a display device, service staff at the service location when the current geographic location of the electronic device of the user is within a second perimeter of the service location.

29. The cloud-based cart assistance method of claim 26, further comprising one or more of:
(i) notifying, via a display device, service staff at the service location the arrival window of the user is about to lapse in a given amount of time, and/or
(ii) notifying, via a display device, service staff at the service location the departure window of the user is about to lapse in a given amount of time.

30. The cloud-based cart assistance method of claim 26, further comprising:
determining, by one or more processors of the server, the state of the cart based on a geographic location of the cart, wherein the state of the cart is updated to a checked-out state when the geographic location of the cart is not at the service location.

31. The cloud-based cart assistance method of claim 30, wherein the state of the cart is updated to the checked-out state when the geographic location of the cart is at or near a third perimeter comprising a coastline of a body of water, and wherein the service location is inland from the coastline.

32. The cloud-based cart assistance method of claim 30, wherein the geographic location of the cart is determined by a current geographic location of the user.

33. The cloud-based cart assistance method of claim 26, wherein the state of the cart is updated to a checked-out state, further comprising:
notifying, via a display device, the user to return the cart to the service location when the departure window of the user is about to lapse in a given amount of time.

34. The cloud-based cart assistance method of claim 26, wherein the state of the cart is updated to a checked-out state, further comprising:
obtaining, by one or more processors of the server, a current geographic location of a second user; and
notifying, via a display device, the user to return the cart to the service location when the current geographic location of the second user is within a fourth perimeter.

35. The cloud-based cart assistance method of claim 26, further comprising:
receiving, by one or more processors of the server, a signal from the user indicating the user is ready for the cart to be picked up by service staff; and
notifying, via a display device, service staff the user is ready for the cart to be picked up at a geographic location of the cart.

36. The cloud-based cart assistance method of claim 26, further comprising:
an application programming interface (API) configured to allow a third-party to access the API and act in place of the user.

37. The cloud-based cart assistance method of claim 26, further comprising one or more of:
(i) alerting, via an electronic device, the user that service is ending,
(ii) alerting, via an electronic device, service staff that service for the user is ending, and/or
(iii) alerting, via an electronic device, a third-party that service for the user is ending.

38. The cloud-based cart assistance method of claim 26, wherein the cart is associated with a two-dimensional barcode (2D barcode), including a unique universal product code (UPC) or a quick response (QR) code, further comprising:
obtaining, by one or more processors of the computing device, an image from an imaging device of the user, the image containing the 2D barcode;
establishing, by one or more processors of the server, an association between the 2D barcode and a user-specific code associated with the user; and
determining, by one or more processors of the server, a geographic location of the cart based on the 2D barcode and a current geographic location of the user determined from the user-specific code.

39. The cloud-based cart assistance method of claim 26, wherein the cart is semi-autonomous, further comprising:
communicating, by one or more processors of the computing device, with sensors on the cart, thereby causing the cart to follow the user.

40. The cloud-based cart assistance method of claim 26, wherein the cart is autonomous, further comprising:
obtaining, by one or more processors of the server, a current geographic location of an electronic device of the user; and
communicating, by one or more processors of the server, with sensors on the cart when the current geographic location of the electronic device of the user is within a fifth perimeter of the service location, thereby causing the cart to autonomously travel to the current geographic location of the electronic device of the user.

41. The cloud-based cart assistance method of claim 26, wherein the cart is autonomous, further comprising:
receiving, by one or more processors of the server, a signal from an electronic device of the user indicating for the cart to return to the service location; and
communicating, by one or more processors of the server, with sensors on the cart, thereby causing the cart to autonomously travel to the service location.

42. The cloud-based cart assistance method of claim 26, wherein the cart is autonomous, further comprising:
receiving, by one or more processors of the server, a signal from an electronic device of the user indicating the cart to return to a current geographic location of the user;
obtaining, by one or more processors of the server, a current geographic location from an electronic device of the user; and
communicating, by one or more processors of the server, with sensors on the cart, thereby causing the cart to autonomously travel to the current geographic location of the user.

43. The cloud-based cart assistance method of claim 26, further comprising:
receiving, by one or more processors of the server, a maintenance signal from sensors on the cart indicating cart performance metrics; and
updating, by one or more processors of the server, the electronic list based on the maintenance signal.

44. The cloud-based cart assistance method of claim 26, wherein the state of a cart further defines a performance state of the cart, further comprising one or more of:
(i) alerting, via an electronic device, service staff when the performance state of a cart indicates the cart is no longer functional;
(ii) identifying, by one or more processors of the server, an available cart with a first performance state indicating the available cart is functional when a second performance state of a reserved cart indicates the reserved cart is no longer functional, and
updating, by one or more processors of the server, the electronic list to indicate a change in the state of the available cart and the state of the reserved cart; and/or
(iii) transmitting, to an electronic device of the service staff by one or more processors of the server, a performance report indicating the performance states of the plurality of carts.

45. The cloud-based cart assistance method of claim 26, further comprising:
determining, by one or more processors of the server, a cart demand value for a future period of time based on one or more of (i) the electronic list, (ii) reservation data, (iii) user data, or (iv) weather data;
determining, by one or more processors of the server, whether the cart demand value is greater than the inventory of the plurality of carts during the future period of time; and
responsive to determining the cart demand value is greater than the inventory of the plurality of carts during the future period of time, alerting, by one or more processors of the server via an electronic device, service staff.

46. The cloud-based cart assistance method of claim 26, further comprising:
determining, by one or more processors of the server, a cart demand value for a future period of time based on one or more of (i) the electronic list, (ii) reservation data, (iii) user data, or (iv) weather data;
determining, by one or more processors of the server, a service staff value for the future period of time based on one or more of (i) a quantity of service staff scheduled to work during the future period of time, (ii) a quantity of service staff on call to work during the future period of time, or (iii) service staff data;
determining, by one or more processors of the server, whether a service capacity ratio exceeds a service capacity threshold, the service capacity ratio based on the cart demand value and the service staff value; and
responsive to determining the service capacity ratio exceeds the service capacity threshold, alerting by one or more processors of the server via an electronic device, service staff.

47. The cloud-based cart assistance method of claim 46, wherein service staff data includes one or more of (i) time sheet data, (ii) availability data, (iii) customer survey data, (iv) performance review data, (v) reliability values, (vi) likeability values, or (vii) efficiency values, further comprising:
determining, by one or more processors of the server, a service staff score for an individual service staff of a plurality of service staff based on service staff data;
determining, by one or more processors of the server, a combination of service staff which would cause the service capacity ratio to not exceed the service capacity threshold; and
scheduling, by one or more processors of the server, the combination of service staff to work during the future period of time.

48. The cloud-based cart assistance method of claim 47, further comprising:
training, by one or more processors of the server, with the service staff data, a machine learning model configured to output a prediction or classification with respect to one or more of: (i) service staff values, (ii) reliability values, (iii) likeability values, (iv) efficiency values, (v) service staff scores, or (vi) combinations of service staff.

49. The cloud-based cart assistance method of claim 26, further comprising:
training, by one or more processors of the server, with one or more of (i) the electronic list, (ii) reservation data, (iii) user data, or (iv) weather data, a machine learning model configured to output a prediction or classification with respect to a cart demand value.

50. The cloud-based cart assistance method of claim 26, wherein the cart is autonomous or semi-autonomous and sensors affixed to the cart are powered by a battery charged by a plurality of solar panels, further comprising:
determining, by one or more processors of the server, solar condition requirements for a cart to operate during a period of time,
determining, by one or more processors of the server, whether solar condition forecasts of the period of time do not meet the solar condition requirements, and
responsive to determining solar condition forecasts of the period of time do not meet the solar condition requirements, alerting, by one or more processors of the server via an electronic device, service staff to charge the battery via an external power source.
